(19) United States
(12) Patent Application Publication
(10) Pub. No.: US 2021/0055018 A1
(43) Pub. Date: Feb. 25, 2021

(54) METHOD FOR DETECTING UNUSUAL CONDITION OF GAS APPLIANCE, AND WATER-HEATING DEVICE

(71) Applicant: KYUNGDONG NAVIEN CO., LTD., Gyeonggi-do (KR)

(72) Inventors: Seung Kil SON, Seoul (KR); Chang Heoi HEO, Seoul (KR); Yong Min SONG, Seoul (KR)

(73) Assignee: KYUNGDONG NAVIEN CO., LTD., Gyeonggi-do (KR)

(21) Appl. No.: 16/998,100

(22) Filed: Aug. 20, 2020

(30) Foreign Application Priority Data
Aug. 23, 2019 (KR) 10-2019-0104045

(51) Int. Cl. F24H 9/20; F24H 1/10; F24D 19/10; G05B 19/042

(52) U.S. Cl. CPC F24H 9/2035; F24H 1/107; G05B 2219/2658; G05B 19/042; F24D 19/1063

(57) ABSTRACT

The present disclosure relates to a method for detecting an unusual condition of a gas appliance, and a water heating device. The method for detecting the unusual condition of the gas appliance equipped with a heat generator including a burner to which gas is supplied as a fuel includes a first step of obtaining a required heating value that the burner has to output to create a predetermined state, a second step of obtaining an indicated heating value corresponding to a control value transmitted to the heat generator for control of the heat generator in the predetermined state, and a third step of determining whether the gas is unusually used, based on the required heating value and the indicated heating value.

### CROSS-REFERENCE TO RELATED APPLICATION

This application claims the benefit of priority to Korean Patent Application No. 10-2019-0104045, filed in the Korean Intellectual Property Office on Aug. 23, 2019, the entire contents of which are incorporated herein by reference.

### TECHNICAL FIELD

The present disclosure relates to a method for detecting an unusual condition of a gas appliance, and a water-heating device. More particularly, the present disclosure relates to a method for detecting whether gas is unusually used in a gas appliance that uses the gas as a fuel, and a water-heating device.

### BACKGROUND

A gas appliance that uses gas as a fuel mixes the gas with air at an appropriate ratio, supplies the mixture to a burner, burns the mixture in the burner through an ignition device, and supplies heat of combustion. For example, in a case where the gas appliance is a hot water supply device, heat of combustion is supplied to a heat exchanger, and hot water is generated through heat exchange. Because the amount of a harmful ingredient, such as carbon monoxide, in exhaust gas varies depending on the mixing ratio of gas and air at the time of combustion, a burner has to be designed to create a gas usage environment appropriate for a product. That is, a product has to be selected and used depending on the type of gas desired to be used, or in a case where gas to be in use is changed, a burner or a gas nozzle of the burner has to be replaced and used depending on gas desired to be used.

In a case where gas not appropriate for a product is used, the product may not normally perform combustion operation, or even though the product performs combustion operation, harmful ingredients in exhaust gas may increase due to a change in the mixing ratio of gas and air. Furthermore, due to this, an accident such as carbon monoxide poisoning by the exhaust gas may occur.

### SUMMARY

The present disclosure has been made to solve the above-mentioned problems occurring in the prior art while advantages achieved by the prior art are maintained intact.

An aspect of the present disclosure provides a method for detecting an unusual condition of a gas appliance, and a water-heating device, wherein when gas not appropriate for product specifications is used in the gas appliance that uses gas as a fuel, whether the gas is unusually used is determined to prevent a malfunction of the gas appliance and occurrence of a safety accident in advance.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for detecting an unusual condition of a gas appliance equipped with a heat generator including a burner to which gas is supplied as a fuel includes a first step of obtaining a required heating value that the burner has to output to create a predetermined state, a second step of obtaining an indicated heating value corresponding to a control value transmitted to the heat generator for control of the heat generator in the predetermined state, and a third step of determining whether the gas is unusually used, based on the required heating value and the indicated heating value.

According to another aspect of the present disclosure, a water-heating device includes a heat generator including a burner to which gas is supplied as a fuel and a controller that controls the heat generator and that determines whether the gas supplied to the burner is unusually used. The controller obtains a required heating value that the burner has to output to create a predetermined state, obtains an indicated heating value corresponding to a control value transmitted to the heat generator for control of the heat generator in the predetermined state, and determines whether the gas is unusually used, based on the required heating value and the indicated heating value.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating a configuration of a water heater that is one example of a gas appliance to which the present disclosure is applied; and

FIG. 2 is a schematic view illustrating a configuration of a boiler for heating and hot water that is another example of the gas appliance to which the present disclosure is applied.

### DETAILED DESCRIPTION

Hereinafter, exemplary embodiments of the present disclosure will be described in detail with reference to the accompanying drawings.

Embodiments to be described below are embodiments appropriate for the understanding of technical features of a method for detecting an unusual condition of a gas appliance, and a water-heating device according to the present disclosure. However, the present disclosure is not limited to the embodiments, and technical features of the present disclosure are not restricted by the embodiments. Furthermore, various changes and modifications can be made without departing from the spirit and scope of the present disclosure.

The present disclosure relates to a method for detecting an unusual condition of a gas appliance equipped with a heat generator including a burner to which gas is supplied as a fuel. No special limitation applies to a gas appliance to which the present disclosure is applied, as long as the gas appliance uses gas as a fuel. For example, the gas appliance may be a water-heating device that generates hot water using heat of combustion of a burner.

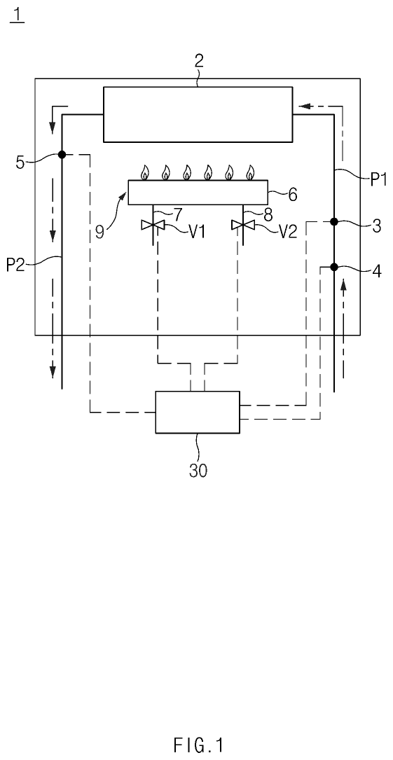

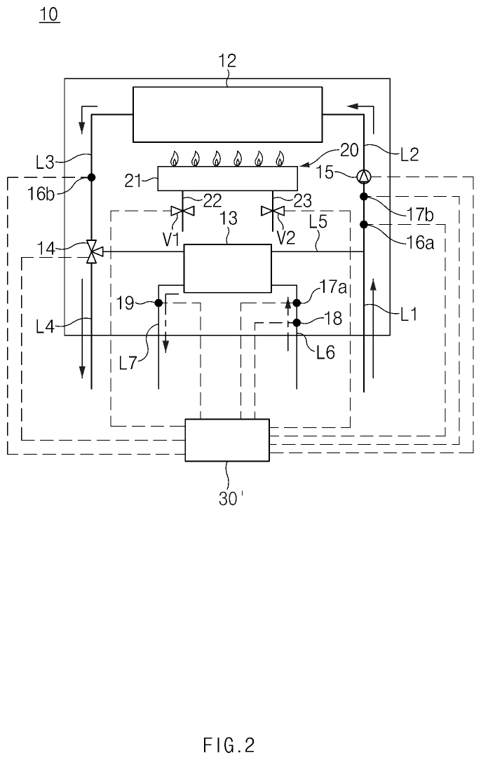

FIG. 1 illustrates a water heater that is one example of the water-heating device, and FIG. 2 illustrates a boiler for heating and hot water that is another example of the water-heating device.

Referring to FIG. 1, a gas appliance 1 may be a water heater. The gas appliance 1 may include a heat generator 9, a heat exchanger 2, a supply water pipe P1, and a hot water pipe P2.

The heat generator 9 may include a burner 6 to which gas is supplied as a fuel, and an air supply line 7 and a fuel supply line 8 connected to the burner 6. A valve V1 that regulates the amount of air supplied to the burner 6 may be connected to the air supply line 7, and a valve V2 that regulates the amount of fuel supplied to the burner 6 may be connected to the fuel supply line 8. The fuel (gas) and the air mixed at an appropriate ratio and supplied to the burner 6 may be burned in the burner 6, and the burner 6 may supply heat of combustion.

The heat exchanger 2 may generate hot water by heating supply water using the heat originating from the burner 6. The supply water with which heat is exchanged in the heat exchanger 2 may be supplied to the supply water pipe P1, and the hot water generated by the heat exchange in the heat exchanger 2 may be released through the hot water pipe P2. Accordingly, the supply water supplied to the supply water pipe P1 when the hot water is used may be changed to the hot water by being heated by the heat exchange while passing through the heat exchanger 2.

The supply water pipe P1 may be equipped with a flow sensor 3 that senses the flow rate of the supply water and a supply water temperature sensor 4 that senses the temperature of the supply water supplied, and the hot water pipe P2 may be equipped with a hot water temperature sensor 5 that senses the temperature of the hot water released.

Referring to the other example of FIG. 2, a gas appliance 10 may be a boiler for heating and hot water. The gas appliance 10 may include a main heat exchanger 12 that heats heating water, heating water circulation pipes L1 and L2, heating water supply pipes L3 and L4, a three-way valve 14 that switches a flow passage to a heating mode or a hot water mode, a boiler circulation pump 15 that circulates water, a connecting pipe L5 that connects the heating water circulation pipes L1 and L2 and the heating water supply pipes L3 and L4, and a hot water heat exchanger 13 that supplies hot water through heat exchange with supply water. The heating water circulation pipe L2 may be equipped with a circulating heating water temperature sensor 16a and a flow sensor 17b, and the heating water supply pipe L3 may be equipped with a heating water supply temperature sensor 16b. In addition, the gas appliance 10 may include a supply water pipe L6 and a hot water pipe L7 connected to the hot water heat exchanger 13. The supply water pipe L6 may be equipped with a supply water temperature sensor 18 and a flow sensor 17a, and the hot water pipe L7 may be equipped with a hot water temperature sensor 19.

A heat generator 20 may include a burner 21 to which gas is supplied, an air supply line 22 and a fuel supply line 23 connected to the burner 21, and valves V1 and V2 connected to the air supply line 22 and the fuel supply line 23. The main heat exchanger 12 and the hot water heat exchanger 13 may be directly or indirectly supplied with heat of combustion of the burner 21. The dash-dot-dash lines in FIGS. 1 and 2 represent a flow of water when hot water is used.

As described above, a gas appliance to which the method according to the present disclosure is applied is not limited to the water-heating device such as the water heater or the boiler for heating and hot water, and the method may be applied to various products, as long as the products are gas appliances that use gas as a fuel.

A basic operation in the water-heating device, such as the water heater or the boiler for heating and hot water, when hot water is used is to sense the use of the hot water through the flow sensor and control the heat generator 9 or 20 so as to supply the hot water at a temperature set by a user. Liquefied petroleum gas (LPG), liquefied natural gas (LNG), town gas, or the like may be supplied to the burner. The characteristics (e.g., heating values) of the gases differ from one another. Therefore, to optimize the mixing ratio of gas (fuel) and air, a gas nozzle has to be selected, and the amount of gas (fuel) and the amount of air appropriate for a heating value have to be determined. In a case where gas not appropriate for product specifications is used, the mixing ratio of gas and air may vary, and due to this, a malfunction of the product (the gas appliance) and a safety accident may occur.

Hereinafter, a first embodiment and a second embodiment of the method for detecting the unusual condition of the gas appliance will be described under the assumption that the gas appliance 1 is a water heater.

### First Embodiment

The method for detecting the unusual condition of the gas appliance according to the present disclosure includes a first step, a second step, and a third step.

The first step is a step of obtaining a required heating value that the burner 6 has to output to create a predetermined state.

Here, the predetermined state may be a state in which a heat medium (e.g., hot water) heated by heat of combustion of the burner 6 reaches a target temperature set by a user and is maintained at the target temperature for a predetermined period of time. The required heating value is a heating value required to reach the predetermined state, that is, a heating value required by the user.

The second step is a step of obtaining an indicated heating value corresponding to a control value that is transmitted to the heat generator 9 for control of the heat generator 9 in the predetermined state.

Specifically, the amounts of gas and air appropriate for the heating value required by the user may be fixed, and the heat generator 9 may be controlled such that the gas and the air are supplied to the burner 6 depending on the required heating value. For example, the amounts of air and fuel supplied to the burner 6 may be adjusted by controlling the valves V1 and V2 provided on the air supply line 7 and the fuel supply line 8 included in the heat generator 9. Alternatively, the mixing ratio of gas and fuel supplied to the burner 6 may be controlled by adjusting the amount of air supplied to the burner 6 through a blower included in the heat generator 9. In another case, the amount of fuel may be adjusted by controlling the valve V2 provided on the fuel supply line 8, and the amount of air may be adjusted by controlling a blower. However, a method for controlling the heat generator 9 is not limited to the method described above, and various methods capable of controlling the amounts of air and gas supplied to the burner 6 may be applied.

The indicated heating value may be a heating value corresponding to the control value that is transmitted to the heat generator 9 for control of the heat generator 9. That is, the indicated heating value may be a heating value that the heat generator 9 supplies when the heat generator 9 is controlled to reach the predetermined state. Here, the first step and the second step are not necessarily performed in a serial order, and the second step may be performed at the same time as, or prior to, the first step.

The third step is a step of determining whether gas is unusually used, based on the required heating value and the indicated heating value.

Specifically, in a case where gas appropriate for product specifications is used, the required heating value and the indicated heating value are similar to each other within an error range. In contrast, in a case where gas not appropriate for the product specifications is used, the amounts of gas and air may vary, and therefore the required heating value and the indicated heating value may differ from each other in the predetermined state.

Accordingly, in the third step, whether gas is unusually used is determined by comparing the required heating value and the indicated heating value in the predetermined state. Here, whether the gas is unusually used includes whether gas appropriate for the product specifications is used, whether a part (e.g., a burner, a gas nozzle, or the like) appropriate for the gas is used, and the like.

As described above, in a case where gas not appropriate for the product specifications is used in the gas appliance 1 that uses gas as a fuel, the present disclosure may determine whether the gas is unusually used, thereby preventing a malfunction of the product and occurrence of a safety accident in advance. When it is determined that the gas is unusually used, the unusual condition may be displayed, and combustion of the burner 6 may be stopped. Accordingly, a malfunction of the gas appliance 1 and a safety accident may be prevented in advance.

In a case where the gas appliance 1 is a water-heating device such as a water heater (refer to FIG. 1), the gas appliance 1 may include the heat exchanger 2 that generates hot water by heating supply water using heat originating from the burner 6, the supply water pipe P1 to which the supply water with which heat is exchanged in the heat exchanger 2 is supplied, and the hot water pipe P2 through which the hot water generated by the heat exchange in the heat exchanger 2 is released.

In this case, the predetermined state may be a state in which the temperature of the hot water released through the hot water pipe P2 reaches a set target temperature and is maintained at the target temperature for a predetermined period of time. The temperature of the hot water may be sensed through the hot water temperature sensor 5 provided on the hot water pipe P2. In a case of calculating a required heating value by using information at the instant when a heating value, a flow rate, temperature, or the like changes, the accuracy may be lowered. Therefore, a required heating value may be calculated and obtained in a state in which the temperature of the hot water is stabilized within an error range of the target temperature. In this case, the accuracy may be improved by applying the average of measurement values measured for a predetermined period of time in the stabilized state. The duration time for the determination of the predetermined state and the predetermined period of time for the calculation of the average may be set in consideration of characteristics of the product and parts.

The first step may include a step of sensing the flow rate of the supply water supplied to the supply water pipe P1 and the temperature of the supply water in the predetermined state and a step of calculating a required heating value, based on the temperature of the hot water, the flow rate of the supply water, and the temperature of the supply water in the predetermined state.

Specifically, the required heating value may be calculated by Equation 1 below. In Equation 1 below, the temperature of the hot water, the temperature of the supply water, and the flow rate of the supply water may each be the average of measurement values measured for the predetermined period of time in the predetermined state. The temperature of the supply water and the flow rate of the supply water may be sensed by the supply water temperature sensor 4 and the flow sensor 3.

Required Heating Value=(Temperature of Hot Water Temperature of Supply water)*Flow Rate of Supply water*60 [Equation 1]

For example, in a case of using a flow rate of 10 L/min under the condition that the target temperature of the hot water is 40 degrees Celsius and the temperature of the supply water is 10 degrees Celsius, the required heating value in the predetermined state is calculated to be 18,000 kcal by Equation 1 above. In a case where gas is normally used, for example, in a case where liquefied natural gas (LNG) is used for a model that uses LNG, the output of a burner when hot water temperature reaches a target temperature in the model in which the maximum output of the burner is 20,000 kcal is maintained to be 18,000 kcal (90% in the case where the maximum output of the burner is 20,000 kcal). In this case, an indicated heating value corresponding to a control value (e.g., an output ratio of 90%) that is transmitted to the heat generator 9 may be 18,000 kcal. Here, the output ratio is applied to the control value, but the control value may be applied in various forms such as the amount of fuel.

However, in a case where gas is unusually used, for example, in a case where liquefied petroleum gas (LPG) is used for a model that uses LNG, a burner may output a required heating value of 18,000 kcal, but an indicated heating value may differ from the required heating value. That is, in the case of using the LPG for the model that uses the LNG, assuming that gas is additionally input by about 1.4 times at the same heating value (the heating value of the LPG being higher than the heating value of the LNG), the burner 6 may be controlled to about 64.3% of the maximum output so as to output a heating value of 18,000 kcal in the predetermined state. However, in this case, the indicated heating value may be 12,860 kcal that is a heating value corresponding to an output ratio of about 64.3% that is a control value transmitted to the heat generator 9.

In a case where a type of gas not appropriate for a product is used, the required heating value may differ from the indicated heating value, and in the third step, whether gas is unusually used is determined by using the difference.

Hereinafter, a specific method for determining whether gas is unusually used in the third step according to the first embodiment of the present disclosure will be described.

The third step may include a first heating value error ratio calculation step, a first reference error ratio calculation step, and a first determination step.

In the first heating value error ratio calculation step, a first heating value error ratio that is the ratio of the required heating value to the indicated heating value may be calculated. That is, the first heating value error ratio may be “(Required Heating Value/Indicated Heating Value)*100”.

In the first reference error ratio calculation step, a first reference error ratio may be calculated based on a preset criterion. Here, the first reference error ratio may be calculated in consideration of an error depending on characteristics of the gas appliance 1.

Specifically, the first reference error ratio calculation step may include a step of calculating an error heating value by reflecting a flow rate error considering a deviation of measurement values of the flow sensor 3 that measures the flow rate of the supply water, a temperature sensor error considering a deviation of measurement values of the temperature sensor that measures the temperature of the supply water and the temperature of the hot water, and a consumption error considering a deviation of flow rates of the hot water released through the hot water pipe P2. Here, the flow rate error and the temperature sensor error that correspond to an error of a part may reflect contents specified according to the specification of the part used. Furthermore, the consumption error corresponding to an error of the gas appliance product may be set within a preset management criterion range.

More specifically, the error heating value may be calculated by Equation 2 below. That is, the error heating value in the first embodiment may be calculated by applying an error reflecting characteristics of the product or the part to the equation for calculating the required heating value. In Equation 2 below, the temperature of the hot water, the temperature of the supply water, and the flow rate of the supply water may each be the average of measurement values measured for the predetermined period of time in the predetermined state.

Error Heating Value=(Temperature of Hot Water−Temperature of Supply water+Temperature Sensor Error)*(Flow Rate of Supply water*Flow Rate Error)*60*Consumption Error [Equation 2]

The first reference error ratio may be calculated by calculating the ratio of the error heating value to the required heating value. That is, the first reference error ratio may be “(Error Heating Value/Required Heating Value)*100”.

In the first determination step, whether gas is unusually used may be determined by comparing the first heating value error ratio and the first reference error ratio.

Specifically, in the first determination step, in a case where the gas appliance 1 is a model that uses LNG, when the first heating value error ratio is higher than the first reference error ratio, it may be determined that gas is unusually used. In contrast, in the first determination step, in a case where the gas appliance 1 is a model that uses LPG, when the first heating value error ratio is lower than the first reference error ratio, it may be determined that gas is unusually used. This is because the heating value of LNG is lower than the heating value of LPG.

Hereinafter, a determination process according to the first embodiment of the present disclosure will be described through a specific embodiment. The gas appliance 1 used in the embodiment is a model that uses LNG, and the maximum output heating value of the burner is 42,000 kcal. In the predetermined state of the embodiment, the heat generator 9 is controlled such that the burner outputs 78.5% of the maximum output heating value. Furthermore, in the embodiment, the consumption error is +5%, the flow rate error is +10%, and the temperature sensor error is +3 degrees Celsius. However, the specification of the gas appliance 1 to which the present disclosure is applied is not limited thereto.

First, a case where LNG is used for the gas appliance 1 will be described. When in the predetermined state, the temperature (target temperature) of the hot water is 49.7 degrees Celsius, the temperature of the supply water is 21 degrees Celsius, and the flow rate of the supply water is 20.8 L/min, the required heating value is as follows.

Required Heating Value=(49.7−21)*20.8 60=35,818 kcal.

Because control is performed to output 78.5% of the maximum output, the indicated heating value is as follows.

Indicated Heating Value=42,000*(78.5/100)=32,970 kcal.

The first heating value error ratio ((Required Heating Value/Indicated Heating Value)*100) is as follows.

First Heating Value Error Ratio=(35,818/32,970)*100=109%

The error heating value ((Temperature of Hot Water−Temperature of Supply water+Temperature Sensor Error) (Flow Rate of Supply water*Flow Rate Error)*60*Consumption Error) and the first reference error ratio ((Error Heating Value/Required Heating Value)*100) are as follows.

Error Heating Value=(49.7−21+3)(20.8*1.1)*60*1.05=45,694 kcal.

First Reference Error Ratio=(45,694*100)/35,818=128%

Because the gas appliance 1 applied to the embodiment is a model that uses LNG and the heating value error ratio (109%) is lower than the reference error ratio (128%), it may be determined in the third step that gas is normally used.

Next, a case where LPG is used for the gas appliance 1 will be described. When in the predetermined state, the temperature (target temperature) of the hot water is 49.3 degrees Celsius, the temperature of the supply water is 21 degrees Celsius, and the flow rate of the supply water is 28.5 L/min, the required heating value is as follows.

Required Heating Value=(49.3−21)*28.5*60=48,393 kcal.

Because control is performed to output 78.5% of the maximum output, the indicated heating value is as follows.

Indicated Heating Value=42,000*(78.5/100)=32,970 kcal.

The first heating value error ratio ((Required Heating Value/Indicated Heating Value)*100) is as follows.

First Heating Value Error Ratio=(48,393/32,970)*100=147%

The error heating value ((Temperature of Hot Water Temperature of Supply water+Temperature Sensor Error) (Flow Rate of Supply water*Flow Rate Error)*60*Consumption Error) and the first reference error ratio ((Error Heating Value/Required Heating Value)*100) are as follows.

Error Heating Value=(49.3−21+3)(28.5*1.1)*60 1.05=61,819 kcal.

First Reference Error Ratio=(61,819*48,393)/100=128%

Because the gas appliance 1 applied to the embodiment is a model that uses LNG and the heating value error ratio (147%) is higher than the reference error ratio (128%), it may be determined in the third step that gas is unusually used. Accordingly, a malfunction and a safety accident may be prevented in advance by stopping operating the gas appliance 1 including the burner.

Meanwhile, the third step may further include an information input step of receiving an input of gas information of a region in which the gas appliance 1 is installed and a step of determining whether gas is unusually used, based on the required heating value and, the indicated heating value, and the gas information that is input in the information input step for comparison with gas information set for the gas appliance 1.

Specifically, in a case where the input gas information of the installation region is in agreement with the gas information set for the gas appliance 1 within an error range, it may be determined that gas in the installation region is appropriate for the gas appliance 1. In contrast, in a case where the input gas information of the installation region is not in agreement with the gas information set for the gas appliance 1, it may be determined that gas in the installation region is not appropriate for the gas appliance 1. Here, the gas information of the installation region may be the type of gas.

Accordingly, in the third step, whether gas is unusually used may be determined by additionally using the gas information of the installation region, and thus the accuracy of the determination may be improved. For example, in a case where a gas appliance using LNG is installed in a region to which LNG is not supplied and the installation region is input, gas information of the installation region stored inside or stored in the Internet and a server is read and compared with set gas information of the product. When the gas information of the installation region is not in agreement with the set gas information of the product, there is a high possibility that gas not appropriate for the product is used.

When the gas information of the installation region is additionally determined, the first reference error ratio for determining whether gas is unusually used may be set to be low, and thus the accuracy of determination as to whether gas is unusually used may be improved. The additional determination may be applied to the second embodiment that will be described below.

### Second Embodiment

Hereinafter, a method for detecting an unusual condition of a gas appliance according to the second embodiment of the present disclosure will be described. The second embodiment of the present disclosure differs from the first embodiment described above in terms of the third step. The following description is focused on the difference from the first embodiment.

The third step according to the second embodiment of the preset disclosure may include a first heating value error ratio calculation step, a second reference error ratio calculation step, and a second determination step.

In the first heating value error ratio calculation step, a first heating value error ratio that is the ratio of a required heating value to an indicated heating value may be calculated. A method for calculating the first heating value error ratio is the same as that in the first embodiment.

In the second reference error ratio calculation step, a second reference error ratio may be calculated based on a pre-stored second heating value error ratio and a preset criterion.

Specifically, the third step according to the second embodiment of the present disclosure is characterized in that the second reference error ratio is calculated by using the pre-stored second heating value error ratio. Here, the second heating value error ratio may be stored after obtained by operating the gas appliance 1 before the calculation of the first heating value error ratio.

For example, the second heating value error ratio may be obtained and stored at the time of inspection in a manufacturing process of the gas appliance 1, or may be obtained and stored when the gas appliance 1 is installed for the first time. However, the time when the second heating value error ratio is stored is not limited thereto, and the second heating value error ratio may be obtained at various time points by the corresponding gas appliance 1 before the first heating value error ratio is calculated.

For example, a case of obtaining the second heating value error ratio when inspecting the gas appliance 1 will be described. A method for obtaining the second heating value error ratio at the time of inspection is the same as the method for calculating the first heating value error ratio in the first embodiment, except that the second heating value error ratio is obtained in the inspection process.

That is, when the temperature of hot water reaches a preset target temperature at the time of inspection and is maintained in a stabilized state for a predetermined period of time, a required heating value at the time of inspection may be calculated by the above-described required heating value equation. In this state, an indicated heating value at the time of inspection may be calculated. The second heating value error ratio may be the ratio of the required heating value at the time of inspection to the indicated heating value at the time of inspection. That is, the second heating value error ratio may be “(Required Heating Value at the Time of Inspection/Indicated Heating Value at the Time of Inspection)*100”. The second heating value error ratio calculated in advance as described above may be stored in storage of the gas appliance 1.

The second reference error ratio may be determined by applying a predetermined range based on the pre-stored second heating value error ratio. Here, the predetermined range may be an error in the installation of the gas appliance 1. That is, the above-described preset criterion may reflect the error in the installation of the gas appliance 1.

Specifically, the second reference error ratio may be “Pre-stored Second Heating Value Error Ratio±x”. Here, “±x” may be the error in the installation of the gas appliance 1. That is, depending on an environment in which the gas appliance 1 is installed, the gas appliance 1, after installed, may not be operated under the same condition as that at the time of inspection in the manufacturing process or at the time of initial installation. For example, whether a cover is mounted at the time of process inspection and the length of an air-supply/exhaust flue may not be applied to the installation environment without change. Furthermore, in a case where the country in which the process inspection is performed differs from the country in which the gas appliance 1 is installed, there may be a difference in the heating value of gas. Accordingly, the accuracy of determination as to whether gas is unusually used may be improved by reflecting an error ratio reflecting the error in the installation.

In the second determination step, whether gas is unusually used may be determined by comparing the first heating value error ratio and the second reference error ratio.

Specifically, in the second determination step, in a case where the gas appliance 1 is a model that uses LNG, when the first heating value error ratio is higher than the second reference error ratio, it may be determined that gas is unusually used. In contrast, in the second determination step, in a case where the gas appliance 1 is a model that uses LPG, when the first heating value error ratio is lower than the second reference error ratio, it may be determined that gas is unusually used.

Hereinafter, a determination process according to the second embodiment of the present disclosure will be described through a specific embodiment. The gas appliance 1 used in the embodiment is a model that uses LNG, and the maximum output heating value of the burner is 42,000 kcal. In the embodiment, in a stabilized state at the time of inspection and a predetermined state after installation, the heat generator 9 is controlled such that the burner outputs 100% of the maximum output heating value. An error ratio in the installation is ±10%. However, the specification of the gas appliance 1 to which the present disclosure is applied is not limited thereto.

First, a case of calculating a second heating value error ratio using LNG at the time of inspection of the gas appliance 1 will be described. When the temperature (target temperature) of hot water is 49.4 degrees Celsius, the temperature of supply water is 21 degrees Celsius, and the flow rate of the supply water is 25.2 L/min in a state in which the temperature of the hot water reaches the target temperature at the time of inspection and is maintained in a stabilized state for a predetermined period of time, a required heating value at the time of inspection is as follows.

Required Heating Value at the Time of Inspection=(49.4−21)*25.2*60=42,941 kcal.

Because control is performed to output 100% of the maximum output, an indicated heating value at the time of inspection is as follows.

Indicated Heating Value at the Time of Inspection=42,000 (100/100)=42,000 kcal.

A second heating value error ratio ((Required Heating Value at the Time of Inspection/Indicated Heating Value at the Time of Inspection)*100) is as follows.

Second Heating Value Error Ratio=(42,941/42,000)*100=102%

The second heating value error ratio calculated at the time of inspection as described above may be stored in internal storage in advance.

Next, a first heating value error ratio may be calculated after the gas appliance 1 is installed.

After the installation, LPG is used, and control is performed to output 100% of the maximum output heating value of the burner. When the temperature (target temperature) of hot water is 48.8 degrees Celsius, the temperature of supply water is 21 degrees Celsius, and the flow rate of the supply water is 34.7 L/min in a predetermined state after the installation of the gas appliance 1, a required heating value is as follows.

Required Heating Value=(48.8−21)*34.7*60=57,880 kcal.

Because control is performed to output 100% of the maximum output, an indicated heating value is as follows.

Indicated Heating Value=42,000*(100/100)=42,000 kcal.

The first heating value error ratio ((Required Heating Value/Indicated Heating Value)*100) is as follows.

First Heating Value Error Ratio=(57,880/42,000)*100=138%

Because a second reference error ratio is “Pre-stored Second Heating Value Error Ratio±x” and “±x” is ±10, the second reference error ratio is as follows.

Second Reference Error Ratio=102+10=112%

Because the gas appliance 1 applied to the embodiment is a model that uses LNG and the heating value error ratio (138%) is higher than the reference error ratio (112%), it may be determined in the third step that gas is unusually used. Accordingly, a malfunction and a safety accident may be prevented in advance by stopping operating the gas appliance 1 including the burner.

The gas appliance 1 is assembled and thereafter released after all parts thereof are identified, inspected, and set. In the inspection of the product, after a gas appropriate for the specification of the corresponding gas appliance 1 is used and burned, all inspections and settings are performed. Thereafter, when it is determined that there is no abnormality, the inspection of the product is completed, and the product is released. Because the second heating value error ratio calculated and stored at the time of inspection of the product reflects a consumption error, a temperature sensor error, a flow rate error, and the like, it is not necessary to consider all product and part errors as when the error heating value is calculated in the first embodiment. Accordingly, the second embodiment may improve the accuracy of determination as to whether gas is unusually used, compared to the first embodiment.

Meanwhile, the water-heating device 1 according to another aspect of the present disclosure includes the heat generator 9 including the burner 6 to which gas is supplied as a fuel and a controller 30 that controls the heat generator 9 and that determines whether the gas supplied to the burner 6 is unusually used.

The controller 30 obtains a required heating value that the burner 6 has to output to create a predetermined state, obtains an indicated heating value corresponding to a control value transmitted to the heat generator for control of the heat generator in the predetermined state, and determines whether the gas is unusually used, based on the required heating value and the indicated heating value.

The water-heating device 1 according to the present disclosure may further include the heat exchanger 2 that generates hot water by heating supply water using heat originating from the burner 6, the supply water pipe P1 to which the supply water with which heat is exchanged in the heat exchanger 2 is supplied, and the hot water pipe P2 through which the hot water generated by the heat exchange in the heat exchanger 2 is released.

The predetermined state may be a state in which the temperature of the hot water released through the hot water pipe P2 reaches a set target temperature and is maintained at the target temperature for a predetermined period of time.

Furthermore, the controller 30 may receive the flow rate of the supply water and the temperature of the supply water that are sensed in the predetermined state and may calculate the required heating value, based on the temperature of the hot water, the flow rate of the supply water, and the temperature of the supply water.

In a case where the gas appliance 1 (FIG. 1) is a water heater, the controller 30 may perform the above-described controls, based on values sensed by the flow sensor 3 and the supply water temperature sensor 4 of the supply water pipe P1 and the hot water temperature sensor 5 of the hot water pipe P2.

Even in a case where the gas appliance 10 (FIG. 2) is a boiler for heating and hot water, a controller 30′ may be identically provided. The controller 30′ may perform the above-described controls, based on values sensed by the circulating heating water temperature sensor 16a and the flow sensor 17b of the heating water circulation pipe L2 (as heating water flows along a closed loop, a fixed value is able to be used in consideration of a pump without a flow sensor) and the heating water supply temperature sensor 16b of the heating water supply pipe L3. Alternatively, the controller 30′ may perform the above-described controls, based on values sensed by the flow sensor 17a and the supply water temperature sensor 18 of the supply water pipe L6 and the hot water temperature sensor 19 of the hot water pipe L7.

The controllers 30 and 30′ may include a processor and a memory. The processor may include a microprocessor such as a field programmable gate array (FPGA), an application specific integrated circuit (ASIC), a central processing unit (CPU), or the like. The memory may store control instructions, on the basis of which the processor generates instructions for control. The memory may be a data store such as a hard disk drive (HDD), a solid state drive (SSD), a volatile medium, a non-volatile medium, or the like.

As described above, in a case where gas not appropriate for product specifications is used in a gas appliance that uses gas as a fuel, the present disclosure may determine whether the gas is unusually used, thereby preventing a malfunction of the gas appliance and occurrence of a safety accident in advance.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for detecting an unusual condition of a gas appliance equipped with a heat generator including a burner to which gas is supplied as a fuel, the method comprising:
a first step of obtaining a required heating value that the burner has to output to create a predetermined state;
a second step of obtaining an indicated heating value corresponding to a control value transmitted to the heat generator for control of the heat generator in the predetermined state; and
a third step of determining whether the gas is unusually used, based on the required heating value and the indicated heating value.

2. The method of claim 1, wherein the gas appliance includes:
a heat exchanger configured to generate hot water by heating supply water using heat originating from the burner;
a supply water pipe to which the supply water with which heat is to be exchanged in the heat exchanger is supplied; and
a hot water pipe through which the hot water generated by the heat exchange in the heat exchanger is released,
wherein the first step includes:
a step of detecting a flow rate and a temperature of the supply water, which is supplied to the supply water pipe, in the predetermined state in which a temperature of the hot water released through the hot water pipe reaches a preset target temperature and is maintained at the preset target temperature for a predetermined period of time; and
a step of calculating the required heating value, based on the temperature of the hot water, the flow rate of the supply water, and the temperature of the supply water in the predetermined state.

3. The method of claim 2, wherein the required heating value is calculated by Equation 1 below:
Required Heating Value=(Temperature of Hot Water−Temperature of Supply water)*Flow Rate of Supply water*60 [Equation 1]
(In Equation 1 above, each of the temperature of the hot water, the temperature of the supply water, and the flow rate of the supply water is an average of values measured for the predetermined period of time in the predetermined state).

4. The method of claim 2, wherein the third step includes:
a first heating value error ratio calculation step of calculating a first heating value error ratio that is the ratio of the required heating value to the indicated heating value;
a first reference error ratio calculation step of calculating a first reference error ratio, based on a preset criterion; and
a first determination step of determining whether the gas is unusually used, by comparing the first heating value error ratio and the first reference error ratio.

5. The method of claim 4, wherein the first reference error ratio is calculated, based on an error depending on characteristics of the gas appliance.

6. The method of claim 4, wherein the first reference error ratio calculation step includes:
a step of calculating an error heating value, based on a flow rate error based on a deviation of measurement values of a flow sensor configured to measure the flow rate of the supply water, a temperature sensor error based on a deviation of measurement values of a temperature sensor configured to measure the temperature of the supply water or the temperature of the hot water, and a consumption error based on a deviation of flow rates of the hot water released through the hot water pipe, and
wherein the first reference error ratio is calculated by calculating the ratio of the error heating value to the required heating value.

7. The method of claim 6, wherein the error heating value is calculated by Equation 2 below:
Error Heating Value=(Temperature of Hot Water−Temperature of Supply water+Temperature Sensor Error)*(Flow Rate of Supply water*Flow Rate Error)*60*Consumption Error [Equation 2]
(In Equation 2 above, each of the temperature of the hot water, the temperature of the supply water, and the flow rate of the supply water is an average of values measured for the predetermined period of time in the predetermined state).

8. The method of claim 1, wherein the third step includes:
a first heating value error ratio calculation step of calculating a first heating value error ratio that is the ratio of the required heating value to the indicated heating value;
a second reference error ratio calculation step of calculating a second reference error ratio, based on a pre-stored second heating value error ratio and a preset criterion; and
a second determination step of determining whether the gas is unusually used, by comparing the first heating value error ratio and the second reference error ratio.

9. The method of claim 8, wherein the second heating value error ratio is stored after obtained by operating the gas appliance before the calculation of the first heating value error ratio.

10. The method of claim 8, wherein the second reference error ratio is calculated by reflecting an error in installation of the gas appliance to the second heating value error ratio.

11. The method of claim 1, wherein the third step includes:
an information input step of receiving an input of gas information of a region in which the gas appliance is installed; and
a step of determining whether the gas is unusually used, based on the required heating value, the indicated heating value, and the gas information that is input in the information input step for comparison with gas information set for the gas appliance.

12. A water-heating device comprising:
a heat generator including a burner to which gas is supplied as a fuel; and
a controller configured to control the heat generator and configured to determine whether the gas supplied to the burner is unusually used,
wherein the controller is configured to:
obtain a required heating value that the burner has to output to create a predetermined state;
obtain an indicated heating value corresponding to a control value transmitted to the heat generator for control of the heat generator in the predetermined state; and
determine whether the gas is unusually used, based on the required heating value and the indicated heating value.

13. The water-heating device of claim 12, further comprising:
a heat exchanger configured to generate hot water by heating supply water using heat originating from the burner;
a supply water pipe to which the supply water with which heat is to be exchanged in the heat exchanger is supplied; and
a hot water pipe through which the hot water generated by the heat exchange in the heat exchanger is released,
wherein the predetermined state is a state in which a temperature of the hot water released through the hot water pipe reaches a preset target temperature and is maintained at the preset target temperature for a predetermined period of time, and
wherein the controller is configured to:
receive a flow rate of the supply water and a temperature of the supply water that are detected in the predetermined state; and
calculate the required heating value, based on the temperature of the hot water, the flow rate of the supply water, and the temperature of the supply water.
